(19) United States
(12) Patent Application Publication
(10) Pub. No.: US 2025/0118781 A1
(43) Pub. Date: Apr. 10, 2025

(54) METHODS OF ACCOUNTING FOR HYDROGEN IN NATURAL GAS SUPPLIED TO RESIDENTIAL AND BUSINESS FACILITY FUEL CELL SYSTEMS

(71) Applicant: WATT Fuel Cell Corp., Mount Pleasant, PA (US)

(72) Inventors: Caine Finnerty, Belle Vernon, PA (US); Paul DeWald, Scottdale, PA (US)

(21) Appl. No.: 18/985,357

(22) Filed: Dec. 18, 2024

Related U.S. Application Data
(63) Continuation of application No. PCT/US2023/026305, filed on Jun. 27, 2023.
(60) Provisional application No. 63/356,207, filed on Jun. 28, 2022.

(51) Int. Cl. H01M 8/0444; H01M 8/0438; H01M 8/04746; H01M 8/0612; H01M 8/0662; H01M 8/24

(52) U.S. Cl. CPC H01M 8/04447; H01M 8/04425; H01M 8/04753; H01M 8/0618; H01M 8/0662; H01M 8/24; H01M 2250/10

(57) ABSTRACT

Provided herein generally are methods of accounting for hydrogen (H2) in a natural gas (NG) stream, i.e., a NG/H2 blend, from a public NG utility to residential and/or business facility fuel cell (FC) systems, where the NG/H2 blend powers the FC systems and the volume of NG/H2 blend supplied to each FC systems is measured. Such measurements along with other data of the operation of the FC system, such as the volume of NG/H2 blend or an increased volume of NG, can be reported or transmitted to the public NG utility for each residential and/or business facility FC system supplied with the NG/H2 blend, where a reduced carbon footprint can be determined for the use of the NG/H2 blend by the FC system(s).

### CROSS-REFERENCE TO RELATED APPLICATION

This application is a continuation of International Application No. PCT/2023/026305, with an international filing date of Jun. 27, 2023, which claims the benefit of and priority to U.S. Provisional Patent Application No. 63/356,207, filed on Jun. 28, 2022, the entire contents of which are incorporated by reference herein.

### BACKGROUND

As the world moves away from fossil fuels and towards renewable and clean or “green” energy, hydrogen energy is an attractive solution to reducing the carbon footprint created by many energy sources. Hydrogen produced from water via electrolysis using a renewable energy source does not produce any greenhouse gases and can be a completely carbon-free process. Fuel cells, which use hydrogen to produce electricity and water, have the possibility to impact clean energy for the future.

Consequently, fuel cell systems continue to be the focus of considerable research due to the potential of fuel cell systems or simply, “fuel cells,” i.e., devices for the electrochemical conversion of hydrogen to electricity, to play a greatly expanded role for general applications including main power units (MPUs) and auxiliary power units (APUs) for households and businesses. Fuel cells also can be used for specialized applications, for example, as on-board electrical generating devices for electric vehicles, backup power sources for residential-use devices, main power sources for leisure-use, outdoor and other power-consuming devices in out-of-grid locations, and lighter weight, higher power density, ambient temperature-independent replacements for portable battery packs.

Because large scale, economic production of hydrogen, infrastructure required for its distribution, and practical means for its storage (especially as a transportation fuel) widely arc believed to be a long way off, much current research and development is directed to the production of the hydrogen used to power fuel cells because many of the current techniques contribute to further carbon emissions. That is, a majority of hydrogen today is produced from fossil fuels such as coal and oil, which in practice produces carbon dioxide, a greenhouse gas.

To that end, fuel cell systems such as solid oxide fuel cell systems, which currently are used in residential applications, typically use natural gas (mainly methane) as a fuel source. The natural gas is reformed into hydrogen, which is used by a fuel cell stack to generate electricity. Depending on the process used to reform the methane, carbon monoxide and/or carbon dioxide can be created as by-products. Consequently, to reduce the carbon footprint of a fuel cell unit further, public natural gas utilities are beginning to experiment with mixing hydrogen into the natural gas supplied to residential fuel cell systems. In this way, the hydrogen is used directly by the fuel cell stack without the need to be reformed thereby not producing any by-product carbon dioxide.

Notwithstanding the feasibility and capability of the current natural gas source piping networks to handle the particular chemical characteristics of the lighter and smaller hydrogen molecule, public natural gas utilities have an issue accounting for the hydrogen used by a particular residential fuel cell system, for example, during a billing cycle. Because the price of hydrogen tends to be more than natural gas, the public natural gas utility needs to account for the amount of hydrogen and natural gas used by the residential fuel cell systems.

Accordingly, methods are needed to account for the amount of hydrogen used by a particular FC system, for example a residential or a business facility FC system, to consider the reduced carbon footprint of such a FC system as well as to invoice appropriately its customers.

### SUMMARY

It has now been discovered that the amount of hydrogen (H2) used by a fuel cell (FC) system during a predetermined time, e.g., in real time or a (monthly) billing cycle, can be accounted for by measuring the flow rate of natural gas (NG), optionally containing H2, through the fuel cell system; and reporting or transmitting data to the public NG utility to account for the amount of H2 supplied to or consumed by the FC system. The NG can include a predetermined amount of H2 present in the NG stream (e.g., a NG/H2 blend) supplied by the public NG utility to the residential and/or business facility FC systems. The reported or transmitted data can be measured and/or determined on a FC system-by-FC system basis, or a customer-by-customer basis. Based on the data, the public NG utility then can invoice a first residential (or business) customer and a second residential (or business) customer appropriate amounts to compensate for the cost of H2 compared to NG per unit volume based on each's consumption. That is, the differently priced gases can be appropriately invoiced to the respective customer, for example, using an increased volume of NG reported or transmitted. Moreover, the data can include or derive the decreased carbon emissions or carbon footprint from the FC system(s).

In various embodiments, the present teachings generally provide a method of accounting for H2 in a NG stream from a public NG utility to residential FC systems, the method comprising: (i) measuring the flow rate of a NG/H2 blend from a public NG utility to a first residential FC system over a predetermined time to provide a volume of the NG/H2 blend supplied to the FC system during the predetermined time, wherein the NG/H2 blend powers the first residential FC system; (ii) reporting or transmitting to the public NG utility data based on the volume of NG/H2 blend supplied to the first residential FC system by the public NG utility during the predetermined time; and (iii) repeating steps (i) and (ii) for a second residential FC system.

In some embodiments, the present teachings generally provide a method of accounting for H2 in a NG stream from a public NG utility to residential FC systems, where each FC system comprising a reformer, a fuel cell stack and an afterburner, and the method generally comprises: (i) measuring the flow rate of a NG/H2 blend supplied from a public NG utility to a first residential FC system over a predetermined time to provide a volume of the NG/H2 blend supplied to the FC system during the predetermined time, wherein the NG/H2 blend powers the first residential FC system, and at least one of the following occurs: a reduction in the temperature of the reformer during the predetermined time, a reduction in the temperature of the fuel cell stack during the predetermined time, a reduction in CO₂ emissions from the afterburner during the predetermined time, a reduction in the temperature of the afterburner during the predetermined time, an increase of the pulse-width modulation (PWM) on a proportional control valve to the fuel cell stack during the predetermined time, and an increase in operating efficiency of the FC system during the predetermined time, wherein the reduction or the increase is in comparison to the FC system operating on only NG; (ii) reporting or transmitting to the public NG utility data based on the volume of NG/H2 blend supplied to the first residential FC system by the public NG utility during the predetermined time; and (iii) repeating steps (i) and (ii) for a second residential FC system.

In certain embodiments, the present teachings generally provide a method of accounting for H2 in a NG stream from a public NG utility to residential FC systems, where each FC system comprising a reformer, a fuel cell stack and an afterburner, and the method generally comprises: (a) measuring the flow rate of NG, optionally comprising H2, supplied from a public NG utility to a first residential FC system over a predetermined time to provide a volume of NG, optionally comprising H2, supplied to the FC system during the predetermined time, wherein the NG, optionally comprising H2, powers the first residential FC system; (b) determining at least one of the following: a reduction in the temperature of the reformer during the predetermined time, a reduction in the temperature of the fuel cell stack during the predetermined time, a reduction in CO₂ emissions from the afterburner during the predetermined time, a reduction in the temperature of the afterburner during the predetermined time, an increase of the PWM on a proportional control valve to the fuel cell stack during the predetermined time, and an increase in operating efficiency of the FC system during the predetermined time, wherein the reduction or the increase is in comparison to the FC system operating on only NG and whereby if at least one of the reductions and increases is present, then determining that H2 is present in the NG; (c) reporting or transmitting to the public NG utility data based on the volume of NG, optionally comprising H2, supplied to the first residential FC system by the public NG utility during the predetermined time; and (d) repeating steps (a) and (c) for a second residential FC system.

### DETAILED DESCRIPTION

As described herein, the present disclosure generally provides methods of accounting for hydrogen (H2) in a natural gas (NG) stream from a public NG utility to residential fuel cell (FC) systems and/or business facility FC systems. As the world moves towards energy sources that reduce the carbon footprint to address global warming concerns, the mixing of H2 into NG streams to residential fuel cell systems is one attempt to reduce that carbon footprint.

Interestingly, H2 has about one-third the energy content as NG per unit volume and H2 typically is more costly than NG. Nevertheless, residential consumers of NG for home FC systems desire H2 in the NG to reduce the carbon footprint created by operation of the fuel cell system. Accordingly, a public NG utility is interested in monitoring and tracking the amount of H2 and NG being consumed by each of its residential FC systems so that it can appropriately bill the respective customer. Measuring the flow rate of NG, optionally including hydrogen (e.g., a NG/H2 blend), through the fuel cell system along with other parameters and conditions of operation of a fuel cell system can provide a basis for data that can be reported or transmitted to the public NG utility for its further use and benefit. For example, determining the volume of NG/H2 blend supplied to a particular FC system, which can be a portion of the entire volume of NG/H2 blend supplied to a residential home or a business facility, permits the determination or tracking of the amount of NG/H2 blend used to generate power rather than what is otherwise consumed, for example, to make heat. Such tracking can be useful in recognizing potential carbon credits and/or other incentives for a reduced carbon footprint (e.g., reduced carbon dioxide emissions) when used by a FC system.

To facilitate an understanding of the present invention, a number of terms and phrases are defined below.

Unless defined otherwise, all technical and scientific terms used herein have the same meaning as commonly understood by one of ordinary skill in the art to which this invention belongs. The abbreviations used herein have their conventional meaning within the chemical arts.

Throughout the description, where systems are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited processing steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of an apparatus or a method described herein can be combined in a variety of ways without departing from the spirit and scope of the present invention, whether explicit or implicit herein. For example, where reference is made to a particular component of a system, that component can be used in various embodiments of systems of the present invention and/or in methods of the present invention, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

The articles “a” and “an” are used in this disclosure to refer to one or more than one (i.e., to at least one) of the grammatical object of the article, unless the context is inappropriate. By way of example, “an element” means one element or more than one element.

The term “and/or” is used in this disclosure to mean either “and” or “or” unless indicated otherwise.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10%, ±5%, ±3% or ±2% variation from the nominal value unless otherwise indicated or inferred from the context.

At various places in the present specification, variable or parameters are disclosed in groups or in ranges. It is specifically intended that the description include each and every individual subcombination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. No language in the specification should be construed as indicating any non-claimed element as essential to the practice of the present invention.

As a general matter, formulations specifying a percentage are by weight unless otherwise specified. Further, if a variable is not accompanied by a definition, then the previous definition of the variable controls.

As used herein, a “NG/H2 blend” refers to natural gas including hydrogen, which may be a predetermined amount of hydrogen.

As used herein, a “residential FC system” refers to a FC system in a residential home, including multi-person homes and multi-unit dwellings such as multi-family homes, apartment complexes, and the like. A “business facility FC system” refers to a FC system in a workplace, for example, a business office (singular or multiple offices), a laboratory or a factory, which is not considered a personal residential. As used herein, for brevity, reference is generally made to a residential FC system; however, the present teaching apply equally to a residential FC system and a business facility FC system, where these terms can be used interchangeably herein, unless understood otherwise from the context.

As used herein, a “fuel cell stack” refers to the component of a fuel cell unit or FC system where the electrochemical reaction takes place to convert hydrogen or electrochemically-oxidizable species to electricity. The fuel cell stack includes cells comprised of an anode, a cathode, and an electrolyte, often formed in layers. In operation, hydrogen and any other electrochemically oxidizable component(s) of a reformate entering a fuel cell stack, for example, from a reformer and/or a fluid mixing device, combine with oxygen anions within an anode layer of the fuel cell stack to produce water and/or carbon monoxide and electrons (electricity). The electrons generated within the anode layer migrate through the external load and back to the cathode layer where oxygen combines with the electrons to provide oxygen anions which selectively pass through the electrolyte layer and the anode layer.

As used herein, a “fuel cell unit” generally refers to a reformer, a fuel cell stack, and an afterburner. A fuel cell unit can include a vaporizer, where an outlet of the vaporizer is in operable fluid communication with an inlet of the reformer and/or the fuel cell stack. The reformer produces hydrogen from a hydrocarbon source, which reformation usually also produces carbon dioxide as a by-product. A fuel cell unit can include various valve assemblies, sensor assemblies, conduits, pumps, blowers and other components associated with such a unit, which other components can be considered the “balance of plant.” The balance of plant can also include pumps, heat exchangers, gaskets, compressors, recirculation blowers, and/or humidifiers.

As used herein, “fuel cell system” generally refers to a fuel cell unit and the balance of plant. A fuel cell system often includes a plurality of fuel cell units. A plurality of fuel cell units can share the balance of plant. It should be understood that a “fuel cell unit” and a “fuel cell system” can be used interchangeably herein unless the context dictates otherwise. Moreover, it should be understood that known and conventional fuel cells come in a variety of types and configurations including phosphoric acid fuel cells (PAFCs), alkaline fuel cells (AFCs), polymer electrolyte membrane (or proton exchange membrane) fuel cells (PEMFCs), and solid oxide fuel cells (SOFCs).

As used herein, a “combined heat and power system” or “CHP system” generally refers to a system that generates electricity and useable heat. A CHP system generates electricity and in doing so, can produce heat that can be captured and used in a variety of ways rather than be discarded as waste heat. Certain types of fuel cell systems can be CHP systems, depending on whether the reforming, electrochemical, and other chemical reactions generate heat, i.e., are exothermic. In such systems, the thermal output typically depends on the electrical output of the fuel cell unit(s). A CHP system can include one or more fuel cell units. A CHP system can include one or more fuel cell units integrated with one or more heater units, and the balance of plant. In such systems where one or more heater units are present, the thermal output can be independent of the electrical output. Accordingly, such a CHP system can provide, at desired levels, a thermal output only, an electrical output only, or both thermal and electrical outputs.

The present teachings provide a method of accounting for H2 in a NG stream from a public NG utility to residential FC systems, where a NG/H2 blend can be used to power the FC systems. The method generally includes measuring the flow rate of the NG/H2 blend supplied from a public NG utility to a first residential FC system over a predetermined time to provide a volume of the NG/H2 blend supplied to the FC system during the predetermined time.

The public NG utility will mix or blend H2 with the NG prior to supplying it to its residential customers such that the NG can have a predetermined amount of H2 present, for example, a NG/H2 blend having or containing 10% H2. Despite knowledge of the amount of H2 present in the NG/H2 blend supplied to the FC systems the public NG utility cannot determine the amount of NG/H2 blend supplied to the individual FC systems in its NG network.

Although at an early stage of development and with questions regarding the ability of the current NG infrastructure to handle the peculiarly different H2 gas, public NG utilities are beginning to introduce hydrogen at about 1% to about 35%, for example, about 5%, about 10%, about 15%, about 20%, about 25%, about 30%, or about 35%, of hydrogen is blended with the NG. Higher amounts of hydrogen may be possible, depending on the construct of the NG pipeline networks and possible improvements thereto, with higher amounts of hydrogen theoretically leading to a reduced negative impact on the environment.

Because of the lower mass per unit volume of H2 compared to NG, an increased volume of reactants (NG/H2 blend) is needed to flow to a fuel cell stack to maintain the same sensor voltage output. Generally the higher the amount of H2 in the NG/H2 blend, a higher volume of the NG/H2 blend needs to flow to the fuel cell stack to maintain a substantially constant voltage output. The flow of the NG/H2 blend to the fuel cell stack often is through a proportional valve. The proportional valve can be controlled using pulse width modulation (PWM), which is a modulation technique that generates variable-width pulses to represent the amplitude of an analog input signal. This modulation technique is helpful in controlling voltage regulation.

For an NG/H2 blend compared to only NG, the PWM associated with the proportional valve between the reactants (e.g., a NG/H2 blend) and fuel cell stack would increase automatically based on feedback from a fuel sensor. The fuel sensor is commonly a thermal based sensor that generates a voltage difference for different volumes of gas flowing through the fuel sensor. The fuel sensor typically is calibrated using the known mass flow of a pure gas, for example, NG itself. In practice, the fuel sensor can maintain a near constant voltage, with the PWM of the proportional valve increasing when a higher volume of NG/H2 blend (i.e., reactants) is needed to maintain a constant mass feedback from the fuel sensor and achieve the same voltage as determined by the precalibrated fuel sensor. The known voltage feedback from the fuel sensor can be used to determine the volume of NG/H2 blend supplied to a particular FC system, which can be a portion of the entire volume of NG/H2 blend supplied to a residential home or a business facility. In this way, the amount of NG/H2 blend used to generate power rather than what is consumed to make heat, for example, by a NG burner, a hot water tank, and/or a stove, can be determined. Such tracking can be useful in recognizing potential carbon credits and/or other incentives for a reduced carbon footprint (e.g., reduced carbon dioxide emissions).

Other changes to the operation and conditions of a FC system can occur when a NG/H2 blend is used, which changes provide secondary checks on the flow of NG/H2 blend to the fuel cell stack. These changes include the temperatures of the reformer, the fuel cell stack, and the afterburner. That is, the hydrogen in a NG/H2 blend causes the exothermic partial oxidation (POX) reactions to be reduced thereby causing the temperature of the reformer to be reduced. Further, the temperature of the fuel cell stack would be reduced and proportionally there would be more water in the exhaust so that the afterburner would run cooler. Moreover, the FC system should experience an increase in operating efficiency.

The flow rate of NG or NG/H2 blend is measured over a predetermined time, which can be in real time (seconds), one minute, several minutes, an hour, 24 hours, a week, 30 days, a month, or whatever time period is desired for tracking the use of gas. The predetermined time period often will be associated with a billing cycle of the public NG utility so that it can properly invoice its customers using an NG/H2 blend.

The predetermined time also permits the determination of the volume of NG or NG/H2 blend that was used during the time period when the flow rate of the NG or NG/H2 blend is measured, which can be determined by measurements and other data collected during operation of the FC system. That is, the data collection of various parameters and conditions during operation of a FC system such as the temperatures of the different components and operating efficiency of the fuel cell stack and FC system assist in maintaining a constant voltage output when the FC system is operated. The energy produced by a FC system also can be instructive of the amount of NG or NG/H2 blend used by the FC system, keeping in mind that H2 has about one-third the energy content per unit volume compared to NG. Accordingly, the methods of the present teachings provide useful data and information beneficial to a public NG utility, which data can be reported or transmitted to it.

More specifically, the methods of the present teachings generally include reporting or transmitting to the public NG utility data based on the volume of NG or NG/H2 blend supplied to the first residential FC system by the public NG utility during the predetermined time. The reported or transmitted data can be or include a variety of information. For example, the data typically include the predetermined time period, start date, end date, and other recordkeeping information.

The reported or transmitted data can include an increased volume of NG compared to the volume of NG/H2 blend supplied to or consumed by a particular FC system. In addition, the data can include the amount or volume of H2 and the amount or volume of NG for a particular NG/H2 blend. The reported or transmitted data can include an increased volume of NG that is proportional to the volume of NG/H2 blend supplied to or consumed by a particular FC system.

Other examples of reported or transmitted data can include a reduction in the temperature of the reformer during the predetermined time, a reduction in the temperature of the fuel cell stack during the predetermined time, a reduction in CO₂ emissions from the afterburner during the predetermined time, a reduction in the temperature of the afterburner during the predetermined time, an increase of the pulse-width modulation (PWM) on a proportional control valve to the fuel cell stack during the predetermined time, and/or an increase in operating efficiency of the FC system during the predetermined time, wherein the reduction or the increase is in comparison to the FC system operating on only NG.

The above described measuring and reporting or transmitting can also be done for a second, third, fourth, and additional residential FC systems, for example, each of the residential FC systems associated with a public NG utility's network. In this way, each customer's use of H2 can be realized and invoiced for its particular volume of NG and/or NG/H2 blend used during a particular billing cycle.

When H2 is introduced into a NG stream supplied to a FC system, the impact on the operation and conditions of the FC system has telltale signs. For example, a reduction in the temperature of the reformer can occur in comparison to the FC system operating on only NG as the H2 supplied does not need to be reformed for use by the fuel cell stack in creating electricity so that the exothermic POX reactions are reduced. Depending on the amount of H2 in the NG/H2 blend, the temperature of the reformer can be reduced from about 5° C. to about 300° C. in comparison to a reformer of the FC system operating on only NG, where higher amounts of H2 generally correspond to increased temperature reduction of the reformer. In various embodiments, the temperature of the reformer is reduced from about 5° C. to about 250° C., about 5° C. to about 200° C., about 5° C. to about 150° C., about 5° C. to about 100° C., about 5° C. to about 80° C., about 5° C. to about 50° C., from about 5° C. to about 30° C. In some embodiments, the temperature of the reformer is reduced about 5° C., about 10° C., about 20° C., about 30° C., about 40° C., about 50° C., about 60° C., about 70° C., about 80° C., about 90° C., about 100° C., about 150° C., about 200° C., about 250° C., or about 300° C.

The H2 supplied also can cause a reduction in the temperature of the fuel cell stack in comparison to the FC system operating on only NG. Depending on the amount of H2 in the NG/H2 blend, the temperature of the fuel cell stack can be reduced from about 5° C. to about 75° C. in comparison to a reformer of the FC system operating on only NG, where higher amounts of H2 generally correspond to increased temperature reduction of the fuel cell stack. In various embodiments, the temperature of the reformer is reduced from about 5° C. to about 60° C., about 5° C. to about 50° C., from about 5° C. to about 40° C., from about 5° C. to about 30° C., or from about 5° C. to about 20° C. In some embodiments, the temperature of the reformer is reduced about 5° C., about 10° C., about 20° C., about 30° C., about 40° C., about 50° C., about 60° C., about 70° C., or about 75° C.

Importantly, a reduction in carbon dioxide (CO₂) emissions from the afterburner can be realized when H2 is mixed in the NG stream, in comparison to the FC system operating on only NG, where higher amounts of H2 generally correspond to a greater reduction of CO₂ emissions from of the afterburner. The reduction in the CO₂ emissions, in comparison to the FC system operating on only NG, can be about 1% to about 20%, or to about 30%, or to about 40% or to about 50%. In particular, the H2 in the NG/H2 blend directly reduces the CO₂ emissions output by about the same amount, i.e., a NG/H2 blend with 20% H2 would reduce the CO₂ emissions output by about 20%. Indeed in certain circumstances, the CO₂ emissions output can be greater than the H2 input as the H2 content promotes steam reforming in the FC system generating additional power per unit of fuel (e.g., NG/H2 blend) supplied to the FC system. In various embodiments, the reduction in the CO₂ emissions can be from about 1% to about 45%, 1% to about 35%, 1% to about 25%, 1% to about 15%, from about 1% to about 10%, or from about 1% to about 5%. In some embodiments, the reduction in the CO₂ emissions can be about 1%, about 2%, about 3%, about 4%, about 5%, about 6%, about 7%, about 8%, about 9%, about 10%, about 15%, about 20%, about 25%, about 30%, about 35%, about 40%, about 45%, or about 50%.

As discussed herein, a reduction in the temperature of the afterburner also can be realized when H2 is mixed in the NG stream, in comparison to the FC system operating on only NG.

Depending on the amount of H2 in the NG/H2 blend, the temperature of the afterburner can be reduced from about 5° C. to about 150° C. in comparison to an afterburner of the FC system operating on only NG, where higher amounts of H2 generally correspond to increased temperature reduction of the afterburner. In various embodiments, the temperature of the afterburner is reduced from about 5° C. to about 125° C., about 5° C. to about 100° C., about 5° C. to about 80° C., from about 5° C. to about 50° C., from about 5° C. to about 30° C., or from about 5° C. to about 20° C. In some embodiments, the temperature of the afterburner is reduced about 5° C., about 10° C., about 20° C., about 30° C., about 40° C., about 50° C., about 60° C., about 70° C., about 80° C., about 90° C., about 100° C., about 110° C., about 120° C., about 130° C., about 140° C., or about 150° C.

An increase of the PWM on a proportional control valve, through which reactants (e.g., a NG/H2 blend) are fed to the fuel cell stack, occurs when H2 is mixed in the NG stream, where the increase is in comparison to the FC system operating on only NG. As discussed herein, the PWM increases as the proportional control valve would need to open wider to allow for the increased volume of NG/H2 blend compared to only NG to maintain a constant mass feedback from the fuel sensor. With a higher H2 content, the PWM will generally increase more. For example, the PWM can increase from about 5% to about 40%, from about 5% to about 35%, from about 5% to about 25%, from about 5% to about 20%, or from about 5% to about 15%. In some embodiments, the PWM can increase about 5%, about 10%, about 15%, about 20%, about 25%, about 30%, about 35%, or about 40%, depending on the H2 content in the NG stream.

With H2 in a NG stream supplied to a FC system, an increase in operating efficiency of the FC system can be realized, where the increase is in comparison to the FC system operating on only NG. The increase in operating efficiency, in comparison to the FC system operating on only NG, can be from about 1% to about 25%, from about 1% to about 20%, from about 1% to about 15%, from about 1% to about 10%, from about 1% to about 7%, from about 1% to about 5%. In some embodiments, the increase in operating efficiency of the FC system can increase about 1%, about 3%, about 5%, about 7%, about 9%, about 10%, about 11%, about 13%, about 14%, about 15%, about 20%, or about 25%.

While each of the above characteristic changes in the operation and measurements and conditions associated with a FC system can be indicative of H2 mixed with the NG, two, three, four, five or six of those increases and reductions is more indicative of H2 being present in the NG running the FC system. That is, for example, if the operating efficiency increases, the FC stack temperature drops, the reformer temperature drops, and the PWM increases, then H2 is most likely present in the NG running the FC system.

In various embodiments of the present teachings, the above described characteristic changes in the operation and measurements and conditions associated with a FC system can be used to determine whether a NG stream contains H2 and can be used to determine how much H2 is in the NG/H2 blend. That is, such methods can include determining at least one of the following: a reduction in the temperature of the reformer during the predetermined time, a reduction in the temperature of the fuel cell stack during the predetermined time, a reduction in CO₂ emissions from the afterburner during the predetermined time, a reduction in the temperature of the afterburner during the predetermined time, an increase of the pulse-width modulation (PWM) on a proportional control valve to the fuel cell stack during the predetermined time, and an increase in operating efficiency of the FC system during the predetermined time, where the reduction or the increase is in comparison to the FC system operating on only NG. If at least one of the reductions and increases is present, then H2 can be present in the NG. If at least two, three, four, five, or six of the reductions and increases is present, then such higher number of reductions and increases is more indicative of H2 present in the NG. Based on the quantitative reductions and/or increases, for example, calibrated changes in the temperature(s) and PWM, the H2 content in a NG/H2 blend can be approximated, within a reasonable standard deviation from the actual amount. Consequently, the data reported to the public NG utility can include the percentage of H2 present in the NG/H2 blend supplied to the FC system and adjust the increased amount of NG reported or transmitted accordingly.

In certain embodiments of the present teachings, the fuel cell units and/or FC systems are associated with a CHP system such that not only can electricity be generated using a NG/H2 blend, but also heat can be generated. Nevertheless, the same methods of measuring, and reporting and transmitting of data of the present teachings are equally applicable for a CHP system.

### EXAMPLES

In order that the disclosure described herein may be more fully understood, the following examples are set forth. The examples should not be construed in any way as limiting the scope of the invention.

A public NG utility supplies a NG/H2 blend including 20% H2 to its residential customers. Certain of its customers have FC systems either as their main electrical power source or as a back-up or auxiliary power system. H2 costs 50% more than NG on a mass/volume basis. One liter of the NG/H2 blend is 1 part H2 and 4 parts NG. Accordingly, the 1 part H2 contributes 1.5 to the total on a cost basis, i.e., 1.5 (for H2)+4 (for NG)=5.5 increased cost basis compared to 5 parts total (of NG), which equates to 5.5/5=1.1 increased volume of NG that needs to be reported based on use of a NG/H2 blend with 20% H2. In other words, the amount of NG/H2 blend used is reported to the public NG utility as an amount of NG that is 10% higher than the actual amount of NG/H2 blend used.

For example, as determined by measuring the flow rate of the above NG/H2 blend (e.g., by use of the fuel sensor), a first residential customer uses 10 L of the 20% H2 NG/H2 blend during a billing cycle. The data then reported or transmitted to the public NG utility includes the use of 10 L NG/H2 blend or 11 L NG (i.e., 10 L×1.1 (cost basis)=11 L NG), for invoicing to the first residential customer for that billing cycle as well as knowing the reduced carbon footprint for that amount of NG/H2 blend.

A second residential customer uses 1000 L of the 20% H2 NG/H2 blend in a billing cycle. The data then reported or transmitted to the public NG utility includes the use of 1000 L NG/H2 blend or 1100 L NG (i.e., 1000×1.1 (cost basis)=1100 L NG), for invoicing to the second residential customer for that billing cycle as well as knowing the reduced carbon footprint for that amount of NG/H2 blend.

In likewise fashion, an unknown content of H2 in a NG/H2 blend can be determined based on the calibrated differences in temperatures of the components of the fuel cell system, increased PWM, and/or increased efficiency of the FC system to then be able to calculate the cost ratio as described above and the increased amount of NG that should be reported or transmitted to the public NG utility to account for the H2 in the NG/H2 blend.

### EQUIVALENTS

The invention may be embodied in other specific forms without departing from the spirit or essential characteristics thereof. The foregoing embodiments are therefore to be considered in all respects illustrative rather than limiting the invention described herein. Scope of the invention is thus indicated by the appended claims rather than by the foregoing description, and all changes that come within the meaning and range of equivalency of the claims are intended to be embraced therein.

1. A method of accounting for hydrogen (H2) in a natural gas (NG) stream from a public NG utility to fuel cell (FC) systems, the method comprising:
(i) measuring the flow rate of NG comprising a predetermined amount of H2 (“NG/H2 blend”) supplied from a public NG utility to a first FC system over a predetermined time to provide a volume of NG/H2 blend supplied to the first FC system during the predetermined time, wherein the NG/H2 blend powers the first FC system;
(ii) reporting or transmitting to the public NG utility data based on the volume of NG/H2 blend supplied to the first FC system by the public NG utility during the predetermined time; and
(iii) repeating steps (i) and (ii) for a second FC system.

2. The method of claim 1, wherein the data comprises an increased volume of NG compared to the volume of NG/H2 blend supplied to the first FC system and to the second FC system to account for the predetermined amount of H2 in the NG.

3. The method of claim 1, wherein the data comprises an increased volume of NG proportional to the volume of the NG/H2 blend supplied to the FC systems.

4. The method of claim 1, wherein the data comprises a volume of the predetermined amount of H2 present in the NG supplied to the first FC system and to the second FC system by the public NG utility.

5. The method of claim 1, wherein the predetermined time is one minute.

6. The method of claim 1, wherein the predetermined time is 30 days.

7. The method of claim 1, wherein the volume of H2 present in the NG stream supplied is about 1% (v/v).

8. The method of claim 1, wherein the volume of H2 present in the NG stream supplied is about 20% (v/v).

9. The method of claim 1, wherein measuring the flow rate comprises measuring the voltage feedback from a fuel sensor associated with the FC system to determine the volume of NG/H2 blend supplied to the FC system during the predetermined time.

10. The method of claim 1, wherein at least one of the first FC system and the second FC system is a residential FC system.

11. The method of claim 1, wherein at least one of the first FC system and the second FC system is a business facility FC system.

12. A method of accounting for hydrogen (H2) in a natural gas (NG) stream from a public NG utility to fuel cell (FC) systems, the method comprising:
(i) measuring the flow rate of NG comprising a predetermined amount of H2 (“NG/H2 blend”) supplied from a public NG utility to a first FC system over a predetermined time to provide a volume of NG/H2 blend supplied to the first FC system during the predetermined time, wherein the NG/H2 blend powers the first FC system, and at least one of the following occurs:
a reduction in the temperature of the reformer during the predetermined time,
a reduction in the temperature of the fuel cell stack during the predetermined time,
a reduction in CO₂ emissions from the afterburner during the predetermined time,
a reduction in the temperature of the afterburner during the predetermined time,
an increase of the pulse-width modulation (PWM) on a proportional control valve to the fuel cell stack during the predetermined time, and
an increase in operating efficiency of the FC system during the predetermined time,
wherein the reduction or the increase is in comparison to the FC system operating on only NG;
(ii) reporting or transmitting to the public NG utility data based on the volume of NG/H2 blend supplied to the first FC system by the public NG utility during the predetermined time; and
(iii) repeating steps (i) and (ii) for a second FC system.

13. The method of claim 12, wherein the reduction in the temperature of the reformer during the predetermined time is from about 5° C. to about 300° C., in comparison to a reformer of the FC system operating on only NG.

14. The method of claim 12, wherein the reduction in the temperature of the fuel cell stack during the predetermined time is from about 5° C. to about 75° C., in comparison to a fuel cell stack of the FC system operating on only NG.

15. The method of claim 12, wherein the reduction in CO₂ emissions from the afterburner during the predetermined time is from about 1% to about 50%, in comparison to an afterburner of the FC system operating on only NG.

16. The method of claim 12, wherein the reduction in the temperature of the afterburner during the predetermined time is from about 5° C. to about 150° C., in comparison to an afterburner of a FC system operating on only NG.

17. The method of claim 12, wherein the increase of the PWM on a proportional control valve to the fuel cell stack is about 5% to about 40%, in comparison to the PWM on a proportional control valve to a fuel cell stack operating on only NG.

18. The method of claim 12, wherein the increase in operating efficiency of the FC system during the predetermined time is from about 1% to about 25%, in comparison to the FC system operating on only NG.

19. A method of accounting for hydrogen (H2) in a natural gas (NG) stream from a public NG utility to fuel cell (FC) systems, each FC system comprising a reformer, a fuel cell stack and an afterburner, the method comprising:
(a) measuring the flow rate of NG, optionally comprising H2, supplied from a public NG utility to a first FC system over a predetermined time to provide a volume of NG, optionally comprising H2, supplied to the first FC system during the predetermined time, wherein the NG, optionally comprising H2, powers the first FC system;
(b) determining at least one of the following:
a reduction in the temperature of the reformer during the predetermined time,
a reduction in the temperature of the fuel cell stack during the predetermined time,
a reduction in CO₂ emissions from the afterburner during the predetermined time,
a reduction in the temperature of the afterburner during the predetermined time,
an increase of the pulse-width modulation (PWM) on a proportional control valve to the fuel cell stack during the predetermined time, and
an increase in operating efficiency of the FC system during the predetermined time,
wherein the reduction or the increase is in comparison to the FC system operating on only NG and whereby if at least one of the reductions and increases is present, then determining that H2 is present in the NG;
(c) reporting or transmitting to the public NG utility data based on the volume of NG, optionally comprising H2, supplied to the first FC system by the public NG utility during the predetermined time; and
(d) repeating steps (a) and (c) for a second FC system.

20. The method of claim 19, wherein in step (b), at least at least two of the reductions and the increases is present.
